(19) United States
(12) Patent Application Publication
(10) Pub. No.: US 2019/0162966 A1
(43) Pub. Date: May 30, 2019

(54) HEAD MOUNTED DISPLAY AND IMAGE DEVICE THEREOF

(71) Applicant: Goldtek Technology Co., Ltd., New Taipei City (TW)

(72) Inventor: YING-TE KUO, Taipei (TW)

(21) Appl. No.: 15/943,797

(22) Filed: Apr. 3, 2018

(30) Foreign Application Priority Data
Nov. 28, 2017 (TW) 106141434

(51) Int. Cl. G02B 27/01; G02B 27/14; G02B 27/28; G02B 5/30

(52) U.S. Cl. CPC G02B 27/0172; G02B 27/14; G02B 27/283; G02B 2027/0123; G02B 2027/0178; G02B 2027/0118; G02B 5/30

(57) ABSTRACT

An image device mountable on a head mounted display device includes a self-light emitting display module, a splitter module, a reflector module and a retarder module. The self-light emitting display module provides a first image light having an image frame. The splitter module is connected to the self-light emitting display module and comprises a splitter interface. The first image light generates a second image light with an optical characteristic via the splitter interface, and the second image light penetrates through the splitter interface due to the optical characteristic. The reflector module is connected to the splitter module. The retarder module is disposed between the reflector module and the splitter module. The retarder module and the self-light emitting module are disposed on different sides of the splitter interface, and the second image light outputs the image frame from the splitter module after the optical characteristic is altered by the retarder module.

### CROSS-REFERENCE TO RELATED APPLICATION

The present disclosure claims priority to Taiwanese patent application No. 106141434, filed on Nov. 28, 2017, the entirety of which is incorporated herein by reference.

### FIELD OF THE INVENTION

The present disclosure relates to an image device, and more particularly, to a head mounted display and image device which displays images that can be observed while the device is worn on the user's head.

### BACKGROUND OF THE INVENTION

Hitherto, display devices have been well developed. Various products began to have integrated display monitor in order to create different user experiences. However, head mounted device is quite different from conventional display devices as it is placed quite close to the user's eyes, which would cause user's sight to be hindered, therefore the display monitors are not suitable to be mounted directly in front of the user's eyes.

### BRIEF SUMMARY OF THE INVENTION

In view of the above-described circumstances, the necessary objective of the present invention is to provide a head mounted display device in which the images are projected to the front of the user's eyes.

The present invention provides an image device that is configured to be constructed on a head mounted display device. The device includes a self-light emitting display module, a splitter module, a reflector module and a retarder module. The self-light emitting display module is for supplying a first image light having an image frame. The splitter module is connected to the self-light emitting display module and comprises a splitter interface. The first image light generates a second image light with an optical characteristic via the splitter interface, and the second image light penetrates through the splitter interface due to the optical characteristic. The reflector module is connected to the splitter module. The retarder module is disposed between the reflector module and the splitter module. The retarder module and the self-light emitting module are disposed on different sides of the splitter interface, and the second image light outputs the image frame from the splitter module after the optical characteristic has been altered by the retarder module.

An embodiment of the present invention provides a head mounted display device. The head mounted display device includes a support frame device that is configured to have a viewing area and an image device that is disposed on the support frame device, a self-light emitting module, a splitter module, a reflector module and a retarder module. The self-light emitting module is for supplying an image light having an image frame. The splitter module is connected to the self-light emitting display module and comprising a splitter interface. The image light generates an optical characteristic via the splitter interface, and the image light penetrates through the splitter interface due to the optical characteristic. The reflector module is connected to the splitter module. The retarder module is disposed between the reflector module and the splitter module. The retarder module and the self-light emitting display module are disposed on the different sides of the splitter interface. The image light is outputted towards the viewing area via the splitter module, the retarder module and the reflector module.

### BRIEF DESCRIPTION OF THE DRAWINGS

The accompanying drawings illustrate one or more embodiments of the present invention and, together with the written description, explain the principles of the present invention. Wherever possible, the same reference numbers are used throughout the drawings referring to the same or like elements of an embodiment.

FIG. 1 is a perspective view of the image device in accordance with a first embodiment of the present disclosure;

FIG. 2 is an exploded perspective view of FIG. 1; and

FIG. 3 is a perspective view of the head mounted display device in accordance with a second embodiment of the present disclosure.

In accordance with common practice, the various described features are not drawn to scale and are drawn to emphasize features relevant to the present disclosure. Like reference characters denote like elements throughout the figures and text.

### DETAILED DESCRIPTION OF THE PREFERRED EMBODIMENTS

The present invention will now be described more fully hereinafter with reference to the accompanying drawings illustrating various exemplary embodiments of the invention. The present invention may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that the terms “and/or” and “at least one” include any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

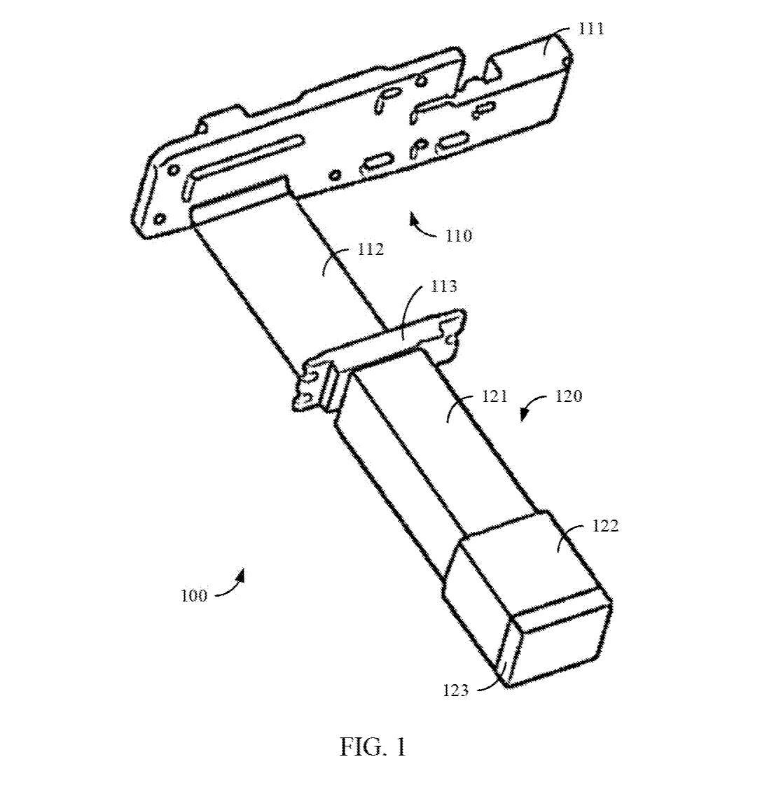

Referring to FIG. 1, a perspective view of the image device 100 in accordance with a first embodiment of the present disclosure. The image device 100 comprises a control module 110 and an image module 120. The control module 110 comprises a processing module 111, a connection module 112 and a display module 113.

In at least one embodiment of the present disclosure, the processing module 111 which may be a processor, a central processing unit (CPU), a graphic processing unit (GPU), a system on chip (SoC), a field programmable gate array (FPGA) or a controller, is to generate an image signal by executing system commands which are stored in RAM (not shown). The processing module 111 which may be an embedded system that contains embedded system commands or an application specific integrated circuit (ASIC). In at least one embodiment of the present disclosure, the processing module 111 which may also be a driving circuit board having a communication unit. The communication unit can be high definition multimedia interface (HDMI), display port or USB configured to receive an image signal provided from an external device. In at least one embodiment of the present disclosure, the communication unit can also adopt customized network protocol or proceed network communication based on standard communication protocols such as Bluetooth, Ethernet, IEEE802.11 series, IEEE802.15 series, wireless USB, infrared ray communication or telecommunication standards including GSM, CDMA2000, TD-SCDMA, WiMAX, LTE or TD-LTE.

In at least one embodiment of the present disclosure, the connection module 112 connects the processing module 111 and the display module 113, for transmitting signals from the processing module 111 to the display module 113, and may be a flexible printed circuits (FPC) or a connection device.

In at least one embodiment of the present disclosure, the display module 113 may comprise a display driving circuit (not shown) and at least one light source (not shown). The display driving circuit drives the at least one light source to illuminate in order to generate an image light having an image frame after receiving a display signal and a power output provided by the processing module 111 via the connection module 112. In at least one embodiment of the present disclosure, the display module may be a self-light emitting display module, the self-light emitting module comprises organic light-emitting diode (OLED) display module, quantum dots light emitting diode (QLED) display module, micro LED display module or other self-light emitting display module.

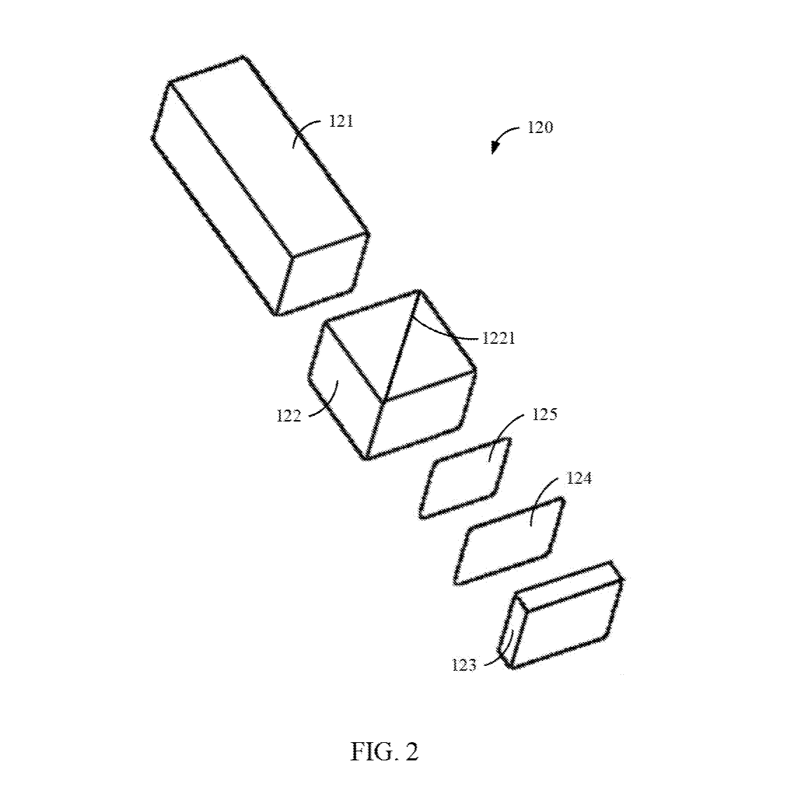

Referring to FIGS. 1 and 2, in which FIG. 2 is an exploded perspective view of the image module 120 of the image device 100 shown in FIG. 1. The image module 120 comprises a transmitting module 121, a splitter module 122, a reflector module 123, a retarder module 124 and an adhesive 125. In at least one embodiment of the present disclosure, the adhesive 125 is disposed between the splitter module 122 and the retarder module 124 so as to strengthen the adhesion between the splitter module 122 and the retarder module 124. In at least one embodiment of the present disclosure, the display module 113, the transmitting module 121, the splitter module 122, the retarder module 124 and the reflector module 123 are arranged in a straight line.

In at least one embodiment of the present disclosure, the transmitting module 121 is disposed between the display module 113 and the splitter module 122 in order to make a connection therebetween for transmitting a first image light containing an image frame provided by the transmitting module 113 to the splitter module 122. In at least one embodiment of the present disclosure, the transmitting module 121 is a photo conductive element such as an optical fiber. In at least one embodiment of the present disclosure, the transmitting module 121 has light focusing effect. Because the first image light provided by the display module 113 is being transmitted scatteredly, a restriction of the transmitting direction of the first image light is therefore applied by the transmitting module 121 to converge the first image light provided by the display module 113 to the splitter module 122. Moreover, to reduce the surrounding stray light on the first image light using the transmitting module 121.

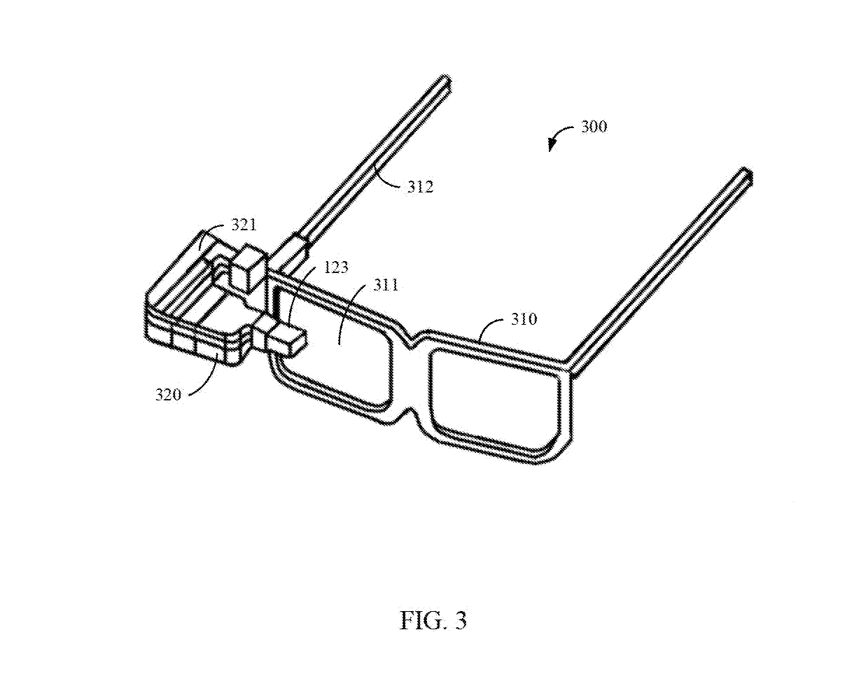

In at least one embodiment of the present disclosure, the splitter module 122 may be a polarizing beam splitters (PBS). The splitter module 122 is connected to the display module 113 via the transmitting module 121. The splitter module 122 has a splitter interface 1221, while the S-polarized light may be reflected by the splitter interface 1221, the P-polarized light may penetrate through. In at least one embodiment of the present disclosure, the first image light may be an unpolarized image light or a random polarized image light. The unpolarized image light or the random polarized image light can be divided into a second image light having a first optical characteristic and a third image light having a second optical characteristic by the splitter interface 1221 of the splitter module 122 when the first image light enters the splitter module 122. In at least one embodiment of the present disclosure, the first optical characteristic is P-polarized, whereas the second optical characteristic is S-polarized. In at least one embodiment of the present disclosure, the display module 113 and the retarder module 124 are disposed on different sides of the splitter interface 1221, when the first image light transmits to the splitter interface 1221, the second image light generated by the splitter interface 1221 can penetrate through the splitter interface 1221 due to its P-polarized optical characteristic and enters the retarder module 124, which is located on the different side from the display module 113. The third image light generated by the splitter interface 1221 is reflected by the splitter interface 1221 due to its S-polarized optical characteristic from the splitter module 122 to the direction opposite to a viewing area 311 shown in FIG. 3, therefore preventing the user of the image device 100 from observing it.

In at least one embodiment of the present disclosure, the retarder module 124 may be a wave plate, and is disposed between the reflector module 123 and the splitter module 122. The retarder module 124 generates a fourth image light having a third optical characteristic by adjusting the first optical characteristic of the second image light. In at least one embodiment of the present disclosure, the reflector module 123 is connected to the splitter module 122, which may be used as a mirror to reflect the light originated from the retarder module 124. The fourth image light would be reflected back to the retarder module 124 from the reflector module 123 after passing through the retarder module 124, so the second image light generated by the splitter module 122 passes through the wave plate twice, then generates a fifth image light having a fourth optical characteristic and re-enters the splitter module 122.

In at least one embodiment of the present disclosure, the retarder module 124 is a quarter wave plate. Since the first optical characteristic is P-polarized, the third optical characteristic generated after the adjustment of the first optical characteristic of the second image light via the quarter wave plate is thus elliptical polarized. In addition, the fourth image light will be reflected back to the retarder module 124 by the reflector module 123, which may be seen as the second image light passing through a half wave plate; therefore, the fourth optical characteristic generated by adjusting the first optical characteristic using the half wave plate becomes S-polarized.

In at least one embodiment of the present disclosure, the reflector module 123, the retarder module 124 and the viewing area 311 shown in FIG. 3 are disposed on the same side of the splitter interface 1221. When the fifth image light is adjusted to be S-polarized by the retarder module 124, the fifth image light is then reflected by the splitter interface 1221 as it transmits to the splitter interface 1221 and output from the splitter module 122 towards the direction of the viewing area 311. The user of the image device 100 can observe the image frame through the fifth image light via the splitter module 122.

FIG. 3 is a perspective view of the head mounted display device 300 of the second embodiment according to the present invention. The head mounted display device 300 comprises a support frame device 310 and a display device 320. The support frame device 310 comprises a viewing area 311. The display device 320 is disposed on the support frame device 310 with a shell 321, the shell 321 covers the image device 100.

In at least one embodiment of the present disclosure, the head mounted display device 300 is a pair of glasses 300. The support frame device 310 of the glasses 300 includes a support frame 312 which extends in reverse of the user's viewing direction so as to secure the support frame device 310 to the user's head. In other words, the support frame extends in a direction parallel but opposite to the viewing direction of the user. In at least one embodiment of the present disclosure, the head mounted display device 300 may be, but is not limited to, a helmet or a hat that can be worn on the user's head.

In at least one embodiment of the present disclosure, although the image device 100 is covered by the shell 321, the splitter module 122 of the image device 100 may be exposed from the shell 321 in the purpose of outputting the image frame by the fifth image light from the splitter module 122 to the viewing area 311. In at least one embodiment of the present disclosure, the portion of the splitter module 122 covered by the shell 321 may be a translucent medium that does not affect output of the fifth image light from the splitter module 122, so that the splitter module 122 can output the fifth image light having the image frame.

In at least one embodiment of the present disclosure, the splitter module 122 outputs the S-polarized fifth image light towards the viewing area 311 to the opposite direction of the user's viewing direction. When the head mounted display device 300 is used as the glasses 300, the splitter module 122 would output the S-polarized fifth image light towards the viewing area 311 along the extending direction of the support frame 312.

Previous descriptions are only embodiments of the present disclosure and are not intended to limit the scope of the present disclosure. Many variations and modifications according to the claims and specification of the disclosure are still within the scope of the claimed disclosure. In addition, each of the embodiments and claims does not have to achieve all the advantages or characteristics disclosed. Moreover, the abstract and the title only serve to facilitate searching patent documents and are not intended in any way to limit the scope of the claimed disclosure.

What is claimed is:

1. An image device to be mounted on a head mounted display device, comprising:
a self-light emitting display module for supplying a first image light having an image frame;
a splitter module connected to the self-light emitting display module and comprising a splitter interface, wherein the first image light generates a second image light with an optical characteristic via the splitter interface, and the second image light penetrates through the splitter interface due to the optical characteristic;
a reflector module connected to the splitter module; and
a retarder module disposed between the reflector module and the splitter module, the retarder module and the self-light emitting module being disposed on different sides of the splitter interface, wherein the second image light outputs the image frame from the splitter module after the optical characteristic has been altered by the retarder module.

2. The image device according to claim 1, further comprising:
a transmitting module disposed between the self-light emitting module and the splitter module, for transmitting the first image light to the splitter module, wherein the self-light emitting module, the transmitting module, the splitter module, the retarder module and the reflector module are arranged in a straight line.

3. The image device according to claim 1, wherein the retarder module comprises a wave plate and the optical characteristic is a first polarization state, the wave plate is configured to convert the second image light having the first polarization state into a third image light having a second polarization state, and to convert the third image light having the second polarization state into a fourth image light having a third polarization state, and the image frame is outputted by the fourth image light after being reflected by the splitter interface.

4. The image device according to claim 1, further comprising:
a processing module connected to the self-light emitting display module; and
a connection module disposed between the processing module and the self-light emitting display module, wherein the connection module drives the self-light emitting module so as to cause the processing module to generate the first image light having the image frame.

5. A head mounted display device, comprising:
a support frame device configured to have a viewing area; and
an image device disposed on the support frame device and comprising:
a self-light emitting module for supplying an image light having an image frame;
a splitter module connected to the self-light emitting display module and comprising a splitter interface, wherein the image light generates an optical characteristic via the splitter interface, and the image light penetrates through the splitter interface due to the optical characteristic;
a reflector module connected to the splitter module; and
a retarder module disposed between the reflector module and the splitter module, the retarder module and the self-light emitting display module being disposed on the different sides of the splitter interface, wherein the image light is outputted towards the viewing area via the splitter module, the retarder module and the reflector module.

6. The head mounted display device according to claim 5, further comprising:
a transmitting module disposed between the self-light emitting display module and the splitter module for transmitting the image light to the splitter module, wherein the self-light emitting display module, the transmitting module, the splitter module, the retarder module and the reflector module are arranged in a straight line.

7. The head mounted display device according to claim 5, wherein the retarder module comprises a wave plate, and the optical characteristic is a polarization state, the image frame is outputted after the image light being reflected by the splitter interface when the polarization state is altered by the wave plate.

8. The head mounted display device according to claim 5, further comprising:
a processing module connected to the self-light emitting display module; and
a connection module disposed between the processing module and the self-light emitting display module, wherein the connection module drives the self-light emitting module so as to cause the processing module to generate the image light having the image frame.
